(19) United States
(12) Patent Application Publication
(10) Pub. No.: US 2023/0196494 A1
(43) Pub. Date: Jun. 22, 2023

(54) NOTIFICATION METHOD, INFORMATION DEVICE, AND STORAGE MEDIUM

(71) Applicant: TOYOTA JIDOSHA KABUSHIKI KAISHA, Toyota-shi Aichi-ken (JP)

(72) Inventors: Taizo MASUDA, Yokohama-shi Kanagawa-ken (JP); Ryota Tomizawa, Mishima-shi Shizuoka-ken (JP); Sei Miyazaki, Susono-shi Shizuoka-ken (JP); Yuki Nishikawa, Susono-shi Shizuoka-ken (JP)

(73) Assignee: TOYOTA JIDOSHA KABUSHIKI KAISHA, Toyota-shi Aichi-ken (JP)

(21) Appl. No.: 17/987,965

(22) Filed: Nov. 16, 2022

(30) Foreign Application Priority Data
Dec. 20, 2021 (JP) 2021-205881

(51) Int. Cl. G06Q 50/30; G06Q 10/02; G08G 1/00

(52) U.S. Cl. CPC G06Q 50/30; G06Q 10/02; G08G 1/202

(57) ABSTRACT

A notification method notifies a user of a vehicle dispatch service about a characteristic of a dispatch vehicle in a vehicle dispatch service. The notification method includes: a first acquisition step of acquiring user information related to a user; a second acquisition step of acquiring characteristic information indicating a characteristic of the dispatch vehicle; and a notification step of notifying a user of characteristic information. In a first case in which the user information does not include information that the user has color blindness, the user is notified of information related to a color of the dispatch vehicle in the notification step. In a second case in which the user information includes the information that the user has color blindness, the user is not notified of the information related to the color of the dispatch vehicle in the notification step.

### CROSS-REFERENCE TO RELATED APPLICATION

This application claims priority to Japanese Patent Application No. 2021-205881 filed on Dec. 20, 2021, incorporated herein by reference in its entirety.

### BACKGROUND

### 1. Technical Field

The present disclosure relates to a notification method, an information device, and a storage medium for notifying a user of information on a dispatch vehicle.

### 2. Description of Related Art

As a method of this type, for example, in a system that arranges transportation services, after a vehicle arrangement is confirmed, information related to a vehicle (vehicle characteristics such as a vehicle model, a size, a capacity, the number, a seat characteristic, a color) is transmitted as additional information to a terminal device owned by a user is proposed (see Japanese Unexamined Patent Application Publication No. 2021-018694 (JP 2021-018694 A)).

### SUMMARY

It is difficult for a person who has color blindness (hereinafter referred to as a “color blind person” as appropriate) to recognize the original color of objects, depending on the extent of the abnormality. A color blind person may also use a transportation service as described above. In the transportation service, when the color of the vehicle is notified to the color blind person as information on the arranged vehicle, there is a risk that the color blind person will feel stressed since it is difficult for the color blind person to recognize the color.

The object is to provide a notification method, an information device, and a storage medium capable of suppressing the stress of a color blind person when using a transportation service.

A notification method according to one aspect of the present disclosure is a notification method for notifying a user of a vehicle dispatch service about a characteristic of a dispatch vehicle to be dispatched in a vehicle dispatch service, the notification method including: a first acquisition step of acquiring user information relating to the user; a second acquisition step of acquiring characteristic information indicating the characteristic of the dispatch vehicle; and a notification step of notifying the user of the characteristic information, in which in a first case where the user information does not include information that the user has color blindness, the user is notified of information related to a color of the dispatch vehicle in the notification step, and in which in a second case where the user information includes the information that the user has color blindness, the user is not notified of the information related to the color in the notification step.

An information device according to one aspect of the present disclosure is an information device for notifying a user of a vehicle dispatch service about a characteristic of a dispatch vehicle to be dispatched, in a vehicle dispatch service, the information device including: a first acquisition unit that acquires user information related to the user; a second acquisition unit that acquires characteristic information indicating the characteristic of the dispatch vehicle; and a notification unit that notifies the user of the characteristic information, in which in a first case where the user information does not include information that the user has color blindness, the notification unit notifies the user of information related to a color of the dispatch vehicle, and in which in a second case where the user information includes information that the user has color blindness, the notification unit does not notify the user of the information related to the color.

A storage medium according to one aspect of the present disclosure is storage medium that stores a computer program that causes a computer mounted on an information device that notifies a user of a vehicle dispatch service about a characteristic of a dispatch vehicle to be dispatched, in the vehicle dispatch service, to function as: a first acquisition unit that acquires user information related to the user; a second acquisition unit that acquires characteristic information indicating the characteristic of the dispatch vehicle; and a notification unit that notifies the user of the characteristic information, in which in a first case where the user information does not include information that the user has color blindness, the notification unit notifies the user of information related to a color of the dispatch vehicle, and in a second case where the user information includes information that the user has color blindness, the notification unit does not notify the user of the information related to the color.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a vehicle dispatch system according to an embodiment;

FIG. 2A is a diagram showing an example of a screen displayed on an information device according to the embodiment;

FIG. 2B is a diagram showing an example of the screen displayed on the information device according to the embodiment;

FIG. 3A is a diagram showing another example of the screen displayed on the information device according to the embodiment;

FIG. 3B is a diagram showing another example of the screen displayed on the information device according to the embodiment;

FIG. 4 is a flow chart showing an operation of the information device according to the embodiment; and

FIG. 5 is a block diagram showing the configuration of a computer according to the embodiment.

### DETAILED DESCRIPTION OF EMBODIMENTS

An embodiment related to a notification method will be explained based on the drawings. In the following embodiment, a notification method in a vehicle dispatch system 1 is explained as an example of the notification method.

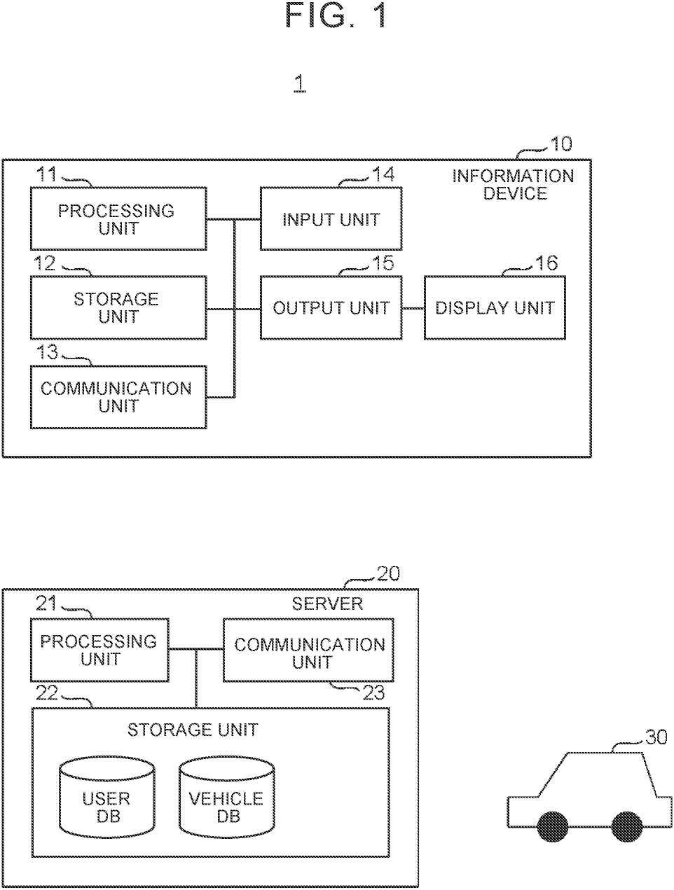

Th embodiment related to the notification method is explained by referring to FIGS. 1 to 4. The vehicle dispatch system 1 according to the embodiment includes an information device 10, a server 20, and a vehicle 30. The information device 10 and the server 20 communicate with each other via a network such as the Internet. The vehicle 30 may be a private vehicle, and is not limited to a commercial vehicle such as a taxi. The vehicle 30 may be an autonomous driving vehicle.

The information device 10 is a device held by a user who uses a vehicle dispatch service provided by the vehicle dispatch system 1 (hereafter simply described as a “vehicle dispatch service”). The information device 10 has a processing unit 11, a storage unit 12, a communication unit 13, an input unit 14, and an output unit 15 as a logically realized logic block or a physically realized processing circuit inside the information device 10. The information device 10 further has a display unit 16.

The input unit 14 can accept input from the user. The input unit 14 may be realized by, for example, a touch panel, a keyboard, etc. The output unit 15 controls the display unit 16 and a speaker 17. The information device 10 may be realized by, for example, a mobile phone, a smart phone, a tablet terminal, etc.

The server 20 includes a processing unit 21, a storage unit 22, and a communication unit 23 as a logically realized logic block or a physically realized processing circuit inside the server 20. The storage unit 22 stores various information relating to the vehicle dispatch service. An example of information stored in the storage unit 22 is information related to a user registered in the vehicle dispatch service (for example, a name, an age, a telephone number, an email address, a payment method, an identification number, etc.: equivalent to a “user database (DB)” in FIG. 1), information related to a vehicle registered in the vehicle dispatch service such as the vehicle 30 (for example, a vehicle number, a vehicle model, a capacity, a color, etc.: equivalent to the “vehicle DB” in FIG. 1), etc.

Next, the outline of an operation of the vehicle dispatch system 1 is explained. An occupant (mainly the driver) of the vehicle 30 transmits vehicle information including information indicating that the vehicle 30 can be provided for the vehicle dispatch service to the server 20. The vehicle information may be transmitted to the server 20 by an information device (not shown) possessed by the passenger, or transmitted to the server 20 by equipment mounted on the vehicle 30.

In addition to information indicating that the vehicle 30 can be provided for the vehicle dispatch service, the vehicle information may include, for example, information indicating a usable date and time, information indicating a usable area, and information for specifying the vehicle 30 (for example a vehicle number, and an identification number set by the vehicle dispatch system 1), etc.

When the processing unit 21 of the server 20 receives the vehicle information from the vehicle 30, the processing unit 21 of the server 20 registers the vehicle 30 in a vehicle list indicating the vehicle capable of being dispatched. The vehicle list may be stored in the storage unit 22.

When making a use reservation of the vehicle dispatch service, the user having the information device 10 inputs, for example, the date, the time, the place, etc., via an input unit 14. The processing unit 11 of the information device 10 transmits request information indicating the date, the time, the place, etc. that are input to the communication unit 13 via the server 20. When the processing unit 21 of the server 20 receives the request information, the processing unit 21 of the server 20 extracts a vehicle candidate that can be dispatched from the vehicle list by referring to the date, the time, the place, etc. The processing unit 21 transmits vehicle candidate information indicating the extracted vehicle candidate to the information device 10 via the communication unit 23.

When the output unit 15 of the information device 10 receives the vehicle candidate information from the server 20, the output unit 15 of the information device 10 controls the display unit 16 so as to display the vehicle candidate information indicated by the vehicle candidate information. When the input unit 14 receives the input for selecting one vehicle among the displayed vehicle candidates, the processing unit 11 transmits the selected vehicle information indicating the selected one vehicle to the server 20 via the communication unit 13.

When the selected vehicle information is received, the processing unit 21 of the server 20 extracts information corresponding to one vehicle indicated by the selected vehicle information from the information relating to the vehicle stored in the storage unit 22, so as to generate the vehicle dispatch information. The processing unit 21 transmits vehicle dispatch information to the information device 10 via the communication unit 23.

The output unit 15 of the information device 10 controls the display unit 16 so as to display the information indicated by the vehicle dispatch information. When the input unit 14 receives the input indicating that a use reservation of the vehicle dispatch service is determined, the processing unit 11 transmits confirmation information indicating that the use reservation has been determined to the server 20 via the communication unit 13. When the processing unit 21 receives the confirmation information, the processing unit 21 of the server 20 transmits the reservation information indicating the contents of the use reservation to the occupant of the vehicle 30 via the communication unit 23.

The information device 10 is configured to be able to acquire information indicating whether the user has color blindness. The information device 10 may provide an item related to color information in the display item of information related to the vehicle dispatch service. The item relating to the color information may be configured so that the user can set the item. The information device 10 may assume that the user has no color blindness when “display the color information” is set for an item related to the color information, for example. On the other hand, the information device 10 may consider that the user has color blindness when, for example, “do not display the color information” is set for an item related to the color information. That is, the information of “display the color information” and “do not display the color information” is an example of information indicating whether the user has color blindness.

Specifically, in this embodiment, a setting state of the item related to the color information is not transmitted to the server 20. The setting state of the item related to the color information may be stored in the storage unit 12. The output unit 15 of the information device 10 selects information displayed on the display unit 16 among the information included in the vehicle dispatch information transmitted from the server 20 based on the setting state of the item related to the color information (in other words, selects information not displayed in the display unit 16). Here, the vehicle dispatch information includes, for example, the date and time, and the place where the vehicle (that is, one vehicle selected by the user) is dispatched, the vehicle number (that is, a license plate number), the color of the vehicle, etc.

When “display the color information” is set for an item related to the color information, the output unit 15 controls the display unit 16 so as to display all the information included in the vehicle dispatch information. As a result, a screen shown in FIG. 2A is displayed (that is, a notification of the vehicle dispatch information is sent to the user).

When the item related to the color information is set to “do not display the color information”, the output unit 15 controls the display unit 16 so as not to display the color information indicating the color of the vehicle among the information included in the vehicle dispatch information. As a result, a screen shown in FIG. 2B is displayed. In this case, the processing unit 11 of the information device 10 may request the server 20 to include information indicating the characteristics of an appearance shape of the vehicle in the vehicle dispatch information. The output unit 15 of the information device 10 that receives the vehicle dispatch information including the information indicating the characteristics of the appearance of the vehicle may control the display unit 16 so as to display the information showing the characteristics of the appearance of the vehicle instead of the information indicating the color of the vehicle (see “headlights are round” in FIG. 2B).

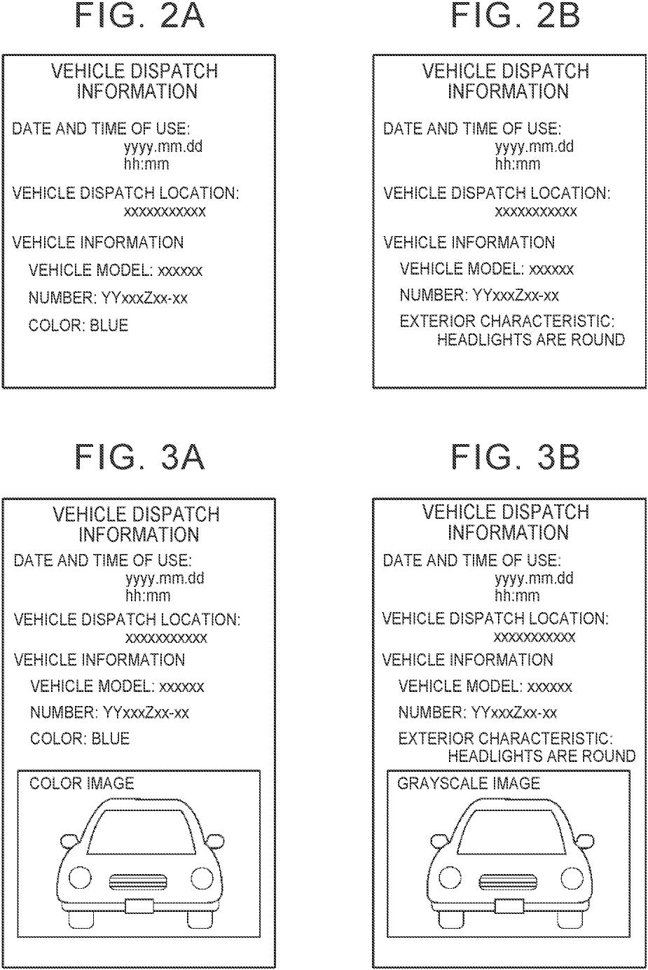

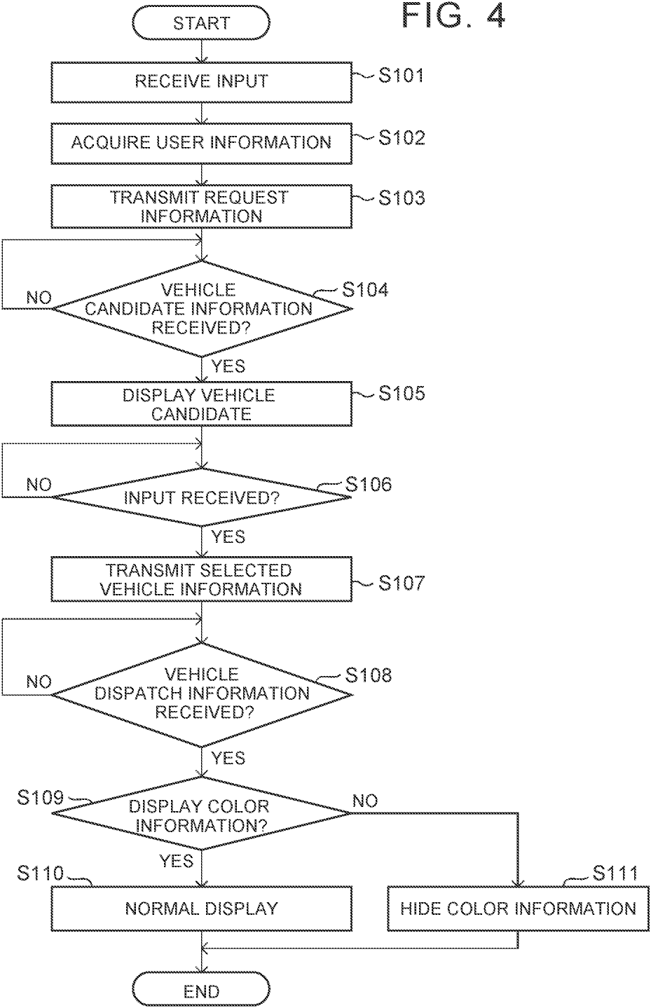

When an image of a vehicle is included in the vehicle dispatch information, the following processing is performed. That is, when “display the color information” is set for an item related to the color information, the output unit 15 may control the display unit 16 so as to display the image of the vehicle included in the vehicle dispatch information as it is. As a result, a screen as shown in FIG. 3A is displayed. On the other hand, when “do not display the color information” is set for an item related to the color information, the output unit 15 may control the display unit 16 so as to display the image of the vehicle included in the vehicle dispatch information after converting the image into a grayscale image, for example. As a result, a screen as shown in FIG. 3B is displayed.

The image of the vehicle included in the vehicle dispatch information is not limited to the image of the vehicle itself that is actually dispatched, but may be an image of the same vehicle model as the vehicle actually dispatched.

Next, the operation of the information device 10 is explained by referring to the flow chart in FIG. 4. In FIG. 4, when the input unit 14 receives the input indicating the date, the time, the place, etc., of using the vehicle dispatch service (step S101), the processing unit 11 acquires user information (step S102).

For example, when a user of the information device 10 uses the vehicle dispatch service for the first time, information for usage registration of the vehicle dispatch system 1 (that is, user registration) may be acquired in the processing of step S102, or the display item of information related to the vehicle dispatch service may be set. In this case, the information for user registration and the setting state of the display item of the information may be acquired as the user information. On the other hand, when user registration has already been performed, in the processing of step S102, the identification number and the setting state of the display item of the information stored in the information device 10 (for example, the storage unit 12) may be acquired as the user information.

After that, the processing unit 11 associates request information (that is, information indicating the date, the time, the place, etc., of using the vehicle dispatch service input in the processing of step S101) and information for specifying the user (that is, information for specifying the user among the user information acquired in the processing of step S102) and transmits the information to the server 20 via the communication unit 13 (step S103). The setting state of the display item of the information is not transmitted to the server 20 at this time.

Next, the processing unit 11 determines whether the vehicle candidate information is received from the server 20 (step S104). In the processing of step S104, when it is determined that the vehicle candidate information is not received from the server 20 (step S104: No), the processing unit 11 performs the processing of the step S104 again. That is, the information device 10 is in a standby state until receiving vehicle candidate information from the server 20.

When it is determined that vehicle candidate information is received from the server 20 in the processing of step S104 (step S104: Yes), the output unit 15 controls the display unit 16 so as to display the vehicle candidate indicated by the vehicle candidate information (step S105). The processing unit 11 determines whether the input for selecting one vehicle among the vehicle candidates is received by the input unit 14 (step S106).

In the processing of step S106, when it is determined that the input for selecting one vehicle among the vehicle candidates is not received (step S106: No), the processing unit 11 performs the processing of the step S106 again. That is, the information device 10 is in a standby state until the input unit 14 accepts the input for selecting one vehicle among the vehicle candidates.

In the processing of step S106, when it is determined that the input for selecting one vehicle among the vehicle candidates is received by the input unit 14 (step S106: Yes), the processing unit 11 transmits the selected vehicle information indicating the selected one vehicle to the server 20 via the communication unit 13 (step S107). The processing unit 11 determines whether the vehicle dispatch information is received from the server 20 (step S108).

In the processing of step S108, when it is determined that the vehicle dispatch information is not received from the server 20 (step S108: No), the processing unit 11 performs the processing of the step S108 again. That is, the information device 10 is in a standby state until receiving the vehicle dispatch information from the server 20. In the processing of step S108, when it is determined that the vehicle dispatch information is received from the server 20 (step S108: Yes), the processing unit 11 determines whether to display the color information based on the setting state of the item related to the color information, among the user information acquired in the processing in the step S102 described above (step S109).

In the processing of step S109, when it is determined that the color information is to be displayed (step S109: Yes), the output unit 15 controls the display unit 16 so as to display the information included in the vehicle dispatch information as it is (that is, performs normal display) (step S110). In the processing of step S109, when it is determined that the color information is not to be displayed (step S109: No), the output unit 15 controls the display unit 16 so as to not display the information indicating the color of the vehicle among the information included in the vehicle dispatch information (step S111).

### Technical Effect

The information device 10 according to the embodiment determines whether to display information indicating the color of the vehicle included in the vehicle dispatch information based on the setting state of the item related to the color information. Therefore, when a color blind person that is a user sets “do not display the color information” for an item related to color information, the user is not notified of the color of the vehicle dispatched in the vehicle dispatch service. Thus, the vehicle dispatch system 1 can suppress the stress of the color blind person when using the transportation service.

Specifically, in this embodiment, a setting state of the item related to the color information is not transmitted to the server 20. Thus, for example, a manager of the server 20 (mainly an operator of the vehicle dispatch system 1) is not informed of whether the user is color blind. Therefore, according to the vehicle dispatch system 1, a vehicle dispatch service that is relatively easy to use even for a person who does not want a third party to know that they are color blind can be provided.

### Modifications

Variations related to notification method is explained. The modification is similar to the embodiment described above, except that the operation of the vehicle dispatch system 1 is partially different. Therefore, a part different from the embodiment described above is explained regarding the modified example, and the explanation of the part overlapping with the embodiment is appropriately omitted.

In the vehicle dispatch system 1 according to the modification, the setting state of the item related to the color information is transmitted from the information device 10 to the server 20. The processing unit 21 of the server 20 may store the setting state of the item related to the color information in the storage unit 22 as a part of the information related to the user.

The processing unit 21 generates the vehicle dispatch information based on the setting state of the item related to the color information included in the information related to the user. Specifically, when the processing unit 21 is set to “display the color information” for the item related to the color information, the processing unit 21 generates the vehicle dispatch information including information indicating the color of the vehicle (that is, the vehicle indicated by the selected vehicle information transmitted from the information device 10). When the vehicle image is included in the vehicle dispatch information, the processing unit 21 may generate the vehicle dispatch information including the color image of the vehicle.

The processing unit 21 generates the vehicle dispatch information not including the information indicating the color of the vehicle when the item related to the color information is set to “do not display the color information”. When the vehicle image is included in the vehicle dispatch information, the processing unit 21 may generate the vehicle dispatch information including the grayscale image of the vehicle.

The output unit 15 of the information device 10 controls the display unit 16 so as to display the information included in the vehicle dispatch information transmitted from the server 20 as it is. As described above, when “do not display the color information” is set for the item related to the color information, the information indicating the color of the vehicle is not included in the vehicle dispatch information. Therefore, even if all the information included in the vehicle dispatch information is displayed, the information indicating the color of the vehicle is not displayed (that is, the user is not notified). With such a configuration, the processing load of the information device 10 can be reduced.

### Computer Program

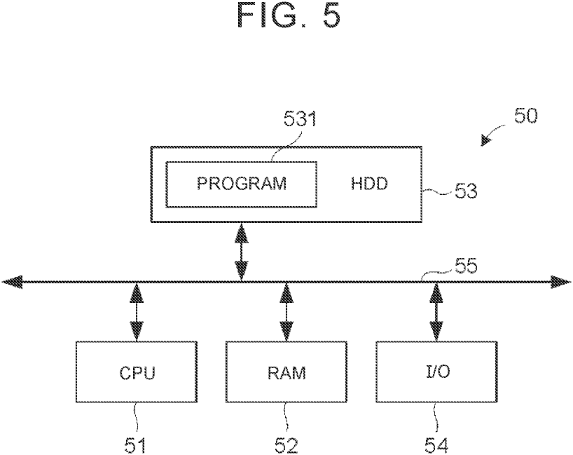

An embodiment related to a computer program is explained by referring to FIG. 5. FIG. 5 is a block diagram showing the configuration of a computer according to the embodiment.

In FIG. 5, a computer 50 is configured to include a central processing unit (CPU) 51, a RAM 52, a hard disk drive (HDD) 53, and an input/output (I/O) 54. The CPU 51, the RAM 52, the HDD 53, and the I/O 54 are connected to each other by a bus 55. A computer program 531 according to the present embodiment is stored in the HDD 53 in advance.

The processing of the CPU 51 by the computer program 531 will be explained. For example, the CPU 51 acquires the user information when receiving input indicating the date, the time, the place, etc of using the vehicle dispatch service. The CPU 51 associates the request information (that is, the received information indicating the date, the time, the place, etc., of using the vehicle dispatch service) with the information for specifying the user and transmits the information to the server 20.

The CPU 51 determines whether the vehicle candidate information is received from the server 20. When it is determined that the vehicle candidate information is received from the server 20, the CPU 51 displays the vehicle candidate indicated by the vehicle candidate information. The CPU 51 determines whether input for selecting one vehicle among the vehicle candidates is received. When it is determined that the input for selecting one vehicle among the vehicle candidates is received, the CPU 51 transmits the selected vehicle information indicating the selected one vehicle to the server 20.

The CPU 51 determines whether the vehicle dispatch information is received from the server 20. When it is determined that the vehicle dispatch information is received from the server 20, the CPU 51 determines whether to display the color information based on the setting state of the item related to the color information among the user information. When it is determined that the information is to be displayed, the CPU 51 displays the vehicle dispatch information as it is (that is, performs normal display). When it is determined that the color information is not to be displayed, the CPU 51 excludes the information indicating the color of the vehicle among the information included in the vehicle dispatch information.

In addition, the computer 50 may, for example, read the computer program 531 from a recording medium (storage medium) storing the computer program 531 such as an optical disk such as a compact disc read only memory (CD-ROM) and a universal recording medium (USB) memory so that the computer program 531 is stored in the HDD 53. Alternatively, the computer 50 may download the computer program 531 via a network such as the Internet, for example, so that the computer program 531 is stored in the HDD 53.

According to the computer program 531, the stress of the color blind person when using the transportation service can be suppressed similarly to the notification method described above. According to the computer program 531, the information device 10 in the embodiment described above can be relatively easily realized.

Various aspects of the disclosure derived from the embodiments and modifications described above are described below.

A notification method according to one aspect of the present disclosure is a notification method for notifying a user of a vehicle dispatch service about a characteristic of a dispatch vehicle to be dispatched, in a vehicle dispatch service, the notification method including: a first acquisition step of acquiring user information related to the user; a second acquisition step of acquiring characteristic information indicating the characteristic of the dispatch vehicle; and a notification step of notifying the user of the characteristic information, in which in a first case where the user information does not include information that the user has color blindness, the user is notified of information related to a color of the dispatch vehicle in the notification step, and in which in a second case where the user information includes the information that the user has color blindness, the user is not notified of the information related to the color in the notification step. In the embodiment described above, the “vehicle dispatch information” corresponds to an example of “characteristic information”.

In the notification method, in the second case, in the notification step, the user may be notified of shape information indicating a characteristic related to a shape of the dispatch vehicle.

In the notification method, in the second case, in the notification step, the information related to the color may be excluded from the characteristic information to be notified to the user.

In the notification method, in the second case, in the second acquisition step, characteristic information not including the information related to color may be acquired as the characteristic information.

An information device according to one aspect of the present disclosure is an information device for notifying a user of a vehicle dispatch service about a characteristic of a dispatch vehicle to be dispatched in a vehicle dispatch service, the information device including: a first acquisition unit that acquires user information related to the user; a second acquisition unit that acquires characteristic information indicating the characteristic of the dispatch vehicle; and a notification unit that notifies the user of the characteristic information, in which in a first case where the user information does not include information that the user has color blindness, the notification unit notifies the user of information related to a color of the dispatch vehicle, and in which in a second case where the user information includes information that the user has color blindness, the notification unit does not notify the user of the information related to the color. In the above embodiment, the “processing unit 11” corresponds to an example of the “first acquisition unit”, the “communication unit 13” corresponds to an example of the “second acquisition unit”, and the “output unit 15” corresponds to an example of the “notification unit”.

A computer program according to one aspect of the present disclosure is a computer program that causes a computer mounted on an information device that notifies a user of a vehicle dispatch service about a characteristic of a dispatch vehicle to be dispatched in the vehicle dispatch service, to function as: a first acquisition unit that acquires user information related to the user; a second acquisition unit that acquires characteristic information indicating the characteristic of the dispatch vehicle; and a notification unit that notifies the user of the characteristic information, in which in a first case where the user information does not include information that the user has color blindness, the notification unit notifies the user of information related to a color of the dispatch vehicle, and in a second case where the user information includes information that the user has color blindness, the notification unit does not notify the user of the information related to the color.

The present disclosure is not limited to the embodiments described above, and can be appropriately changed to the extent that it does not contradict the abstract or idea of the disclosure that can be read from the scope of the claims and the entire specification, and a notification method, an information device, a computer program accompanied by such a change are also included in the technical scope of the present disclosure.

What is claimed is:

1. A notification method for notifying a user of a vehicle dispatch service about a characteristic of a dispatch vehicle to be dispatched in a vehicle dispatch service, the notification method comprising:
a first acquisition step of acquiring user information related to the user;
a second acquisition step of acquiring characteristic information indicating the characteristic of the dispatch vehicle; and
a notification step of notifying the user of the characteristic information,
wherein in a first case where the user information does not include information that the user has color blindness, the user is notified of information related to a color of the dispatch vehicle in the notification step, and
wherein in a second case where the user information includes the information that the user has color blindness, the user is not notified of the information related to the color in the notification step.

2. The notification method according to claim 1, wherein in the second case, in the notification step, the user is notified of shape information indicating a characteristic related to a shape of the dispatch vehicle.

3. The notification method according to claim 1, wherein in the second case, in the notification step, the information related to the color is excluded from the characteristic information to be notified to the user.

4. The notification method according to claim 1, wherein in the second case, in the second acquisition step, characteristic information not including the information related to the color is acquired as the characteristic information.

5. An information device for notifying a user of a vehicle dispatch service about a characteristic of a dispatch vehicle to be dispatched in a vehicle dispatch service, the information device comprising:
a first acquisition unit that acquires user information related to the user;
a second acquisition unit that acquires characteristic information indicating the characteristic of the dispatch vehicle; and
a notification unit that notifies the user of the characteristic information,
wherein in a first case where the user information does not include information that the user has color blindness, the notification unit notifies the user of information related to a color of the dispatch vehicle, and
wherein in a second case where the user information includes information that the user has color blindness, the notification unit does not notify the user of the information related to the color.

6. A non-transitory storage medium that stores a computer program that causes a computer mounted on an information device that notifies a user of a vehicle dispatch service about a characteristic of a dispatch vehicle to be dispatched in the vehicle dispatch service, to function as:
a first acquisition unit that acquires user information related to the user;
a second acquisition unit that acquires characteristic information indicating the characteristic of the dispatch vehicle; and
a notification unit that notifies the user of the characteristic information, in which in a first case where the user information does not include information that the user has color blindness, the notification unit notifies the user of information related to a color of the dispatch vehicle, and in a second case where the user information includes information that the user has color blindness, the notification unit does not notify the user of the information related to the color.
